(19) United States
(12) Patent Application Publication
(10) Pub. No.: US 2009/0089123 A1
(43) Pub. Date: Apr. 2, 2009

(54) Method and a Tool for Performance Measurement of a Business Scenario Step Executed by a Single User

(76) Inventors: Sylvia Delcheva, Walldorf (DE); Rumiana Angelova, Wiesloch (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/147,865

(22) Filed: Jun. 27, 2008

Related U.S. Application Data
(60) Provisional application No. 60/947,295, filed on Jun. 29, 2007.

(51) Int. Cl. G06Q 10/00

(52) U.S. Cl. 705/7

(57) ABSTRACT

Described herein are a method and a tool for performance measurement of a business scenario step in an enterprise environment, which support “per business scenario step” granularity and do not attach any agents to the enterprise environment, thus avoiding any memory or CPU time overheads. The performance measurements are based on two sets of system readings collected prior to the and after the execution of the business scenario step. The method calculates the memory used by the enterprise environment during the business scenario step execution, the elapsed CPU times used by all Operation System (OS) processes involved, the number and duration of all roundtrips between the Hyper Text Transfer Protocol (HTTP) browser initiating the execution of the business scenario step and the enterprise environment, and between the enterprise environment and all back-ends involved.

This application claims the benefit of provisional application No. 60/947,295, filed on Jun. 29, 2007, entitled “Single User Measurements for Java”.

### FIELD OF INVENTION

The field of invention relates generally to software, and in particular but not exclusively relates to performance measurements of a business scenario step, executed by a single user in an enterprise environment.

### BACKGROUND

Performance measurements are essential part of the quality assurance processes, which need to be performed early enough in product development phase and on regular bases to be able to determine if direction of development is correct and if the product is satisfying the requirements of the customers.

There are two aspects of the performance measurement: single user measurement and a load test, which work together to ensure the positive end-user experience with the developed product. Load testing requires broad expertise in landscape management and software tuning, load tests scripting and load simulation, as well as extensive knowledge and experience as a tester. Single user measurements on the other hand, are manageable by every quality expert or scenario owner, even by every developer who maintains a test case for checking the functional correctness of his development unit. Because of this and considering the relatively low-price of single user performance measurements, they become the basis of performance regression tracking and searching for optimization potential throughout the stack.

One major disadvantage of the existing performance measurement solutions is that they use numerous agents to attach to the enterprise environment in order to collect a set of system readings needed to measure the performance. These agents generate significant memory overhead and additional Central Processing Unit (CPU) time usage, thus making the performance measurements inaccurate. Further, the existing solutions do not provide information with granularity “per business scenario step”, but “per request”. In practice, one scenario step may consist of one, but most typically more than one, request from the browser to server and also from server to back-end. An example of such a business step would be a logon operation on a web portal. Currently it is not possible to realize which requests belong together and to aggregate the measurements and achieve the required “per business scenario step” granularity.

### SUMMARY

Described herein are a method and a tool for performance measurement of a business scenario step in an enterprise environment, which support “per business scenario step” granularity and do not attach any agents to the enterprise environment, thus avoiding any memory or CPU time overheads. The performance measurements are based on two sets of system readings collected prior to the and after the execution of the business scenario step. The method calculates the memory used by the enterprise environment during the business scenario step execution, the elapsed CPU times used by all Operation System (OS) processes involved, the number and duration of all roundtrips between the Hyper Text Transfer Protocol (HTTP) browser initiating the execution of the business scenario step and the enterprise environment, and between the enterprise environment and all back-ends involved.

### BRIEF DESCRIPTION OF THE DRAWINGS

A better understanding of the present invention can be obtained from the following detailed description in conjunction with the following drawings, in which:

FIG. 1 is a block diagram of a Performance Measurement Tool (PM Tool) in an enterprise environment, in accordance with an embodiment of the present invention.

FIG. 2 is a flow diagram of a performance measurement process in an enterprise environment, in accordance with an embodiment of the present invention.

FIG. 3 is a sequence diagram of a user-managed performance measurement process in an enterprise environment, in accordance with an embodiment of the present invention.

FIG. 4 is a sequence diagram of an automated performance measurement process in an enterprise environment, in accordance with an embodiment of the present invention.

FIG. 5 is an example of a predefined list of business scenario steps, in accordance with an embodiment of the present invention.

FIG. 6 is an example of a user readable measurement report, generated by the PM Tool, in accordance with an embodiment of the present invention.

### DETAILED DESCRIPTION

Embodiments of a method, tool and machine readable medium for performance measurement of a business scenario step executed by a single user in an enterprise environment are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

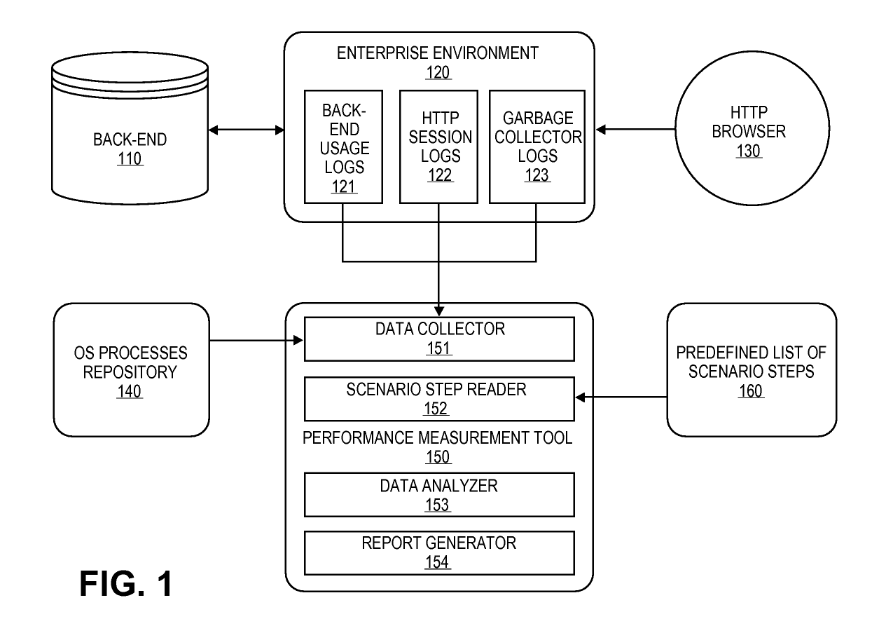

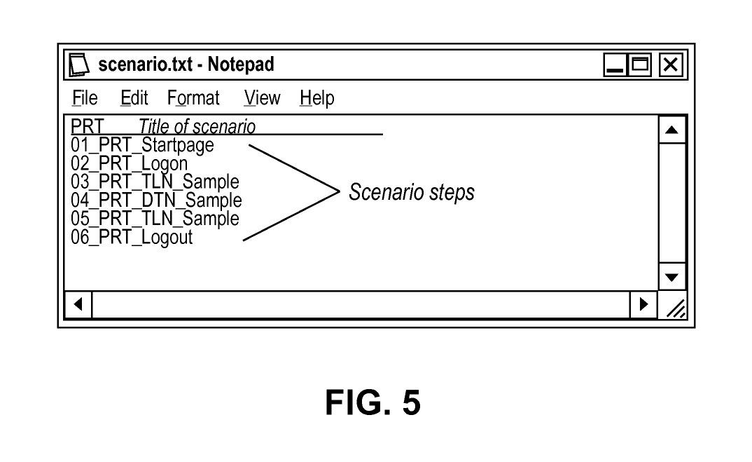

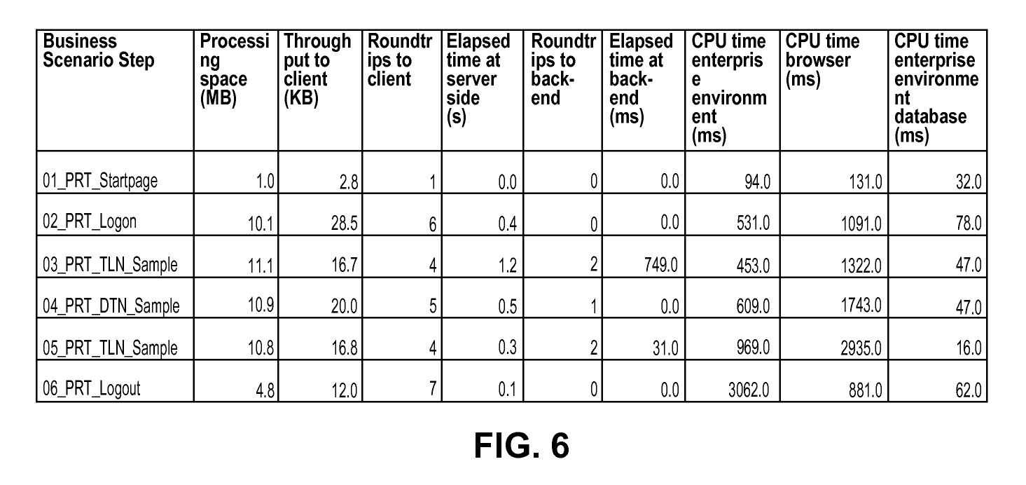

FIG. 1 is a block diagram of a Performance Measurement Tool 150 (PM Tool) in an enterprise environment. The Data Collector 151 is configured to attach to the Back-end usage logs 121, HTTP session logs 122 and Garbage Collector (GC) logs 123 of the Enterprise Environment 120 in order to be able to collect system readings regarding the memory consumption of the Enterprise Environment 120, the behavior of the GC, and the roundtrips between the HTTP browser 130 and the Back-end 110. The Data Collector 151 receives information about the elapsed CPU times of the processes involved in the enterprise environment from the OS Process Repository 140. The Scenario Step Reader 142 is attached to the Predefined List of Scenario Steps 160 in order to receive information about the business scenario step which is going to be executed. In one embodiment of the invention the Predefined List of Scenario Steps 160 may be kept in a file as described in reference to FIG. 5 below. The Data Analyzer 153 measures the performance of the executed business scenario step by analyzing the readings collected by the Data Collector 151 prior to and after the execution of the business scenario step. The Report Generator 154 generates user readable reports about the performance measured by the Data Analyzer 153. In one embodiment of the invention, the report may be organized in a table as described in reference to FIG. 6 below.

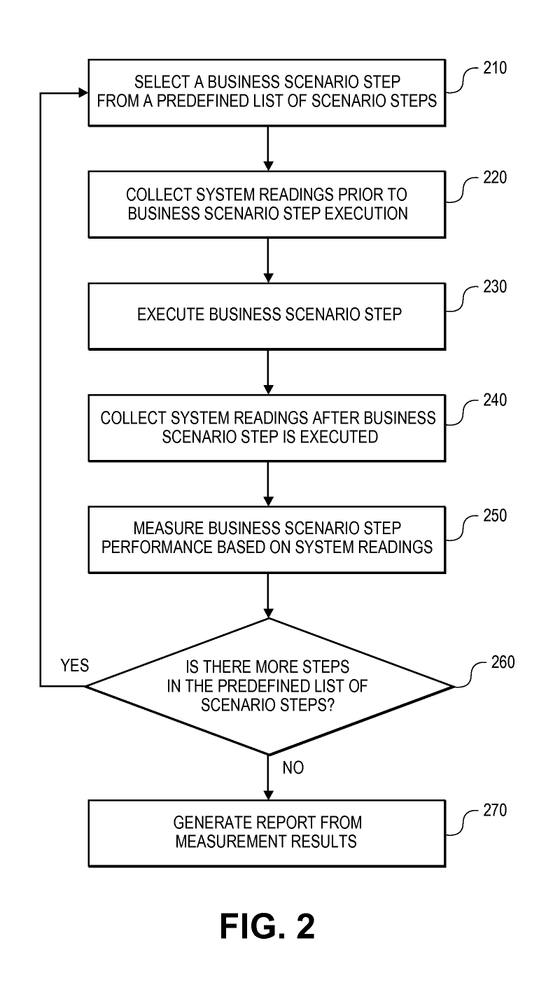

FIG. 2 is a flow diagram of a performance measurement process in an enterprise environment. At block 210, the PM Tool selects the current business scenario step to be executed from the Predefined List of Scenario Steps. At block 220, the PM Tool collects the first set of system readings prior to the business scenario step execution. In one embodiment, the first set of system readings may include the current memory usage of the enterprise environment, the elapsed CPU times of all processes involved, and three pointers designating the end of each of the enterprise environment log files as described in reference to FIG. 1 above. At block 230, the business scenario step is executed. Immediately after the execution is completed, at block 240, the PM Tool collects the second set of system readings from the enterprise environment logs. Besides the amount of memory used by the enterprise environment and the elapsed CPU times of all processes involved at the end of the business step execution, the second set of system readings includes the portions of the enterprise environment Back-end Usage, HTTP and GC logs, generated during the execution of the business scenario step. Thus, the PM Tool acquires all necessary information to measure the performance of the business scenario step with no additional overhead generated because it does not interact with the enterprise environment during business step execution. Further, the PM Tool does not limit the business step to a single request. The granularity is flexible and can be determined by the user according to the measured scenario. The system readings acquired by the PM Tool are most accurate if there is only one user working with the enterprise environment at the time of the execution of the business scenario step.

At block 250, the PM Tool parses the portions of the HTTP session and back-end usage logs acquired with the second set of system readings to extract information about all incoming and outgoing requests in the enterprise environment. The PM tool uses this information to determine the number and the duration of all roundtrips between the HTTP browser and the enterprise environment, and between the enterprise environment and the back-end. The PM Tool calculates the elapsed CPU times of the processes involved by comparing the deviations between the corresponding values in the first and the second sets of system readings. The actual memory used by the enterprise environment on each business scenario step is calculated by subtracting the initial amount of memory from the amount of memory measured after the execution and adding the amount of garbage collected memory, determined by parsing the GC logs portion. After the measurements for the executed business scenario step are calculated, a check if there are more steps to be executed in the Predefined List of Scenario Steps is performed at block 260. If there are more steps, the next step is selected and the processes described at blocks 210-250 are repeated. If there are no more steps to be executed, the PM Tool generates a report from the measurement results for all executed business scenario steps. In practice, the process is repeated several times in order to achieve maximum accuracy as it is possible for background running processes to interfere with the performance measurements.

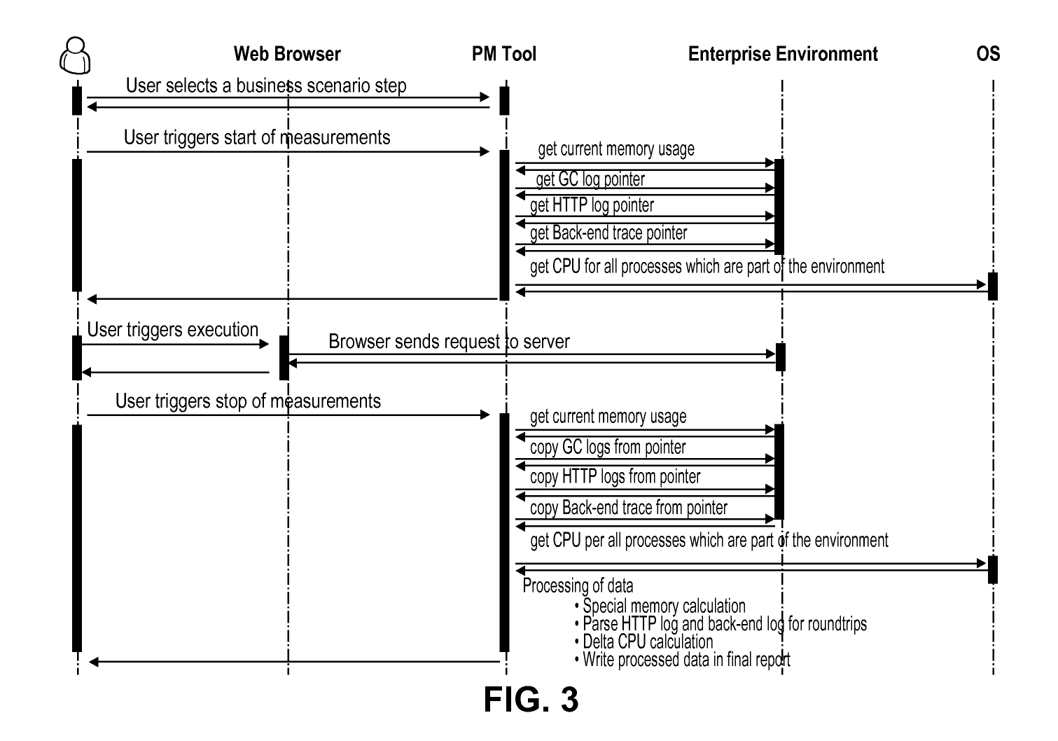

FIG. 3 is a sequence diagram of a user-managed performance measurement process in an enterprise environment. In the embodiment as described in reference to FIG. 3 below, all PM Tool actions are triggered manually. A user determines the business scenario step to be executed. Once the step is specified, the user triggers collection of the first set of system readings. In one embodiment, the PM Tool may provide a user interface and a set of commands for user interaction. After the PM Tool collects the first set of system readings, the user executes the business scenario step interacting with the HTTP browser. The user triggers collection of the second set of system readings after the business scenario step is executed and the PM Tool performs the data analysis. In one embodiment, the user may repeat the execution of the same business scenario step several times until the deviations between results after each execution is low enough to guarantee measurement precision.

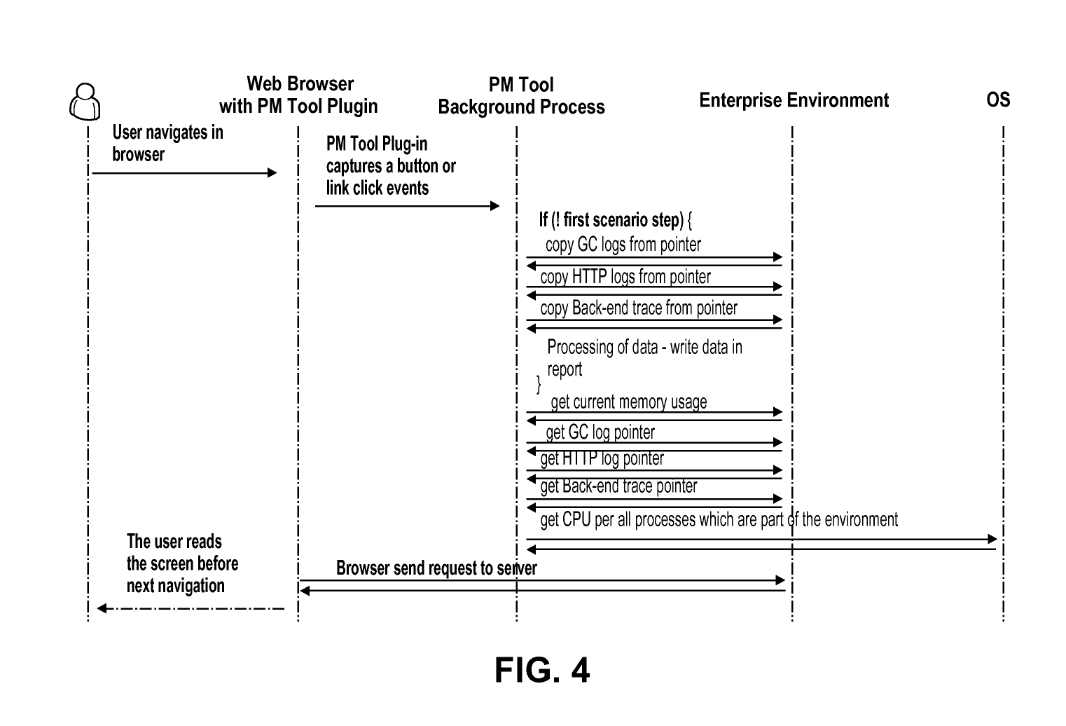

FIG. 4 is a sequence diagram of an automated performance measurement process in an enterprise environment. In the embodiment as described in reference to FIG. 4 below, the PM Tool works as a background process, communicating with the HTTP browser via a plug-in. When a user navigates in the HTTP browser, the plug-in captures the button or link click events and sends a notification to the PM Tool to collect the set of system readings. If the first business scenario step is going to be executed, the PM Tool collects the first set of system readings. On each subsequent step, the PM Tool collects the second set of system readings and shifts the pointers to the end of the enterprise environment log files as described in reference to FIG. 1 above.

FIG. 5 is an example of a predefined list of business scenario steps. In this example, the list is kept in a text file. The first line of the file describes the business scenario name. This name may be used as an identifier of the measurement results repository for storing all collected data for this scenario. Starting from the second line of the file, the business scenario steps are sequentially described. In practice, the business scenario step names follow a convention in order to improve the readability of the generated results. In one embodiment the business scenario step naming convention may be: <order_number>_<scenario_name>_<specific_step_name>.

FIG. 6 is an example of a user readable measurement report, generated by the PM Tool. In this example, the results are organized in a table. Each row represents a business scenario step, while each column represents a specific measurement. In order to improve the readability of the generated results, the granularity of the measurements must be specified accordingly. It is a good practice to avoid measuring separately business scenario steps with CPU times less than 50 ms. In such cases the small steps should be integrated in one major step and measured together. The result will be average of total CPU time or total memory used and number of repetitions. Too fine granularity is not recommended also due to the massive amount of measurement data that will be collected and maintained. Recommended granularity is per browser page or per functional unit, for example create new user, deploy an application on the enterprise environment, etc.

The above description of illustrated embodiments of the invention, including what is described in the Abstract, is not intended to be exhaustive or to limit the invention to the precise forms disclosed. While specific embodiments of, and examples for the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for performance measurement of a business scenario step in an enterprise environment, comprising:
identifying a business scenario step;
collecting a first set of system readings prior to execution of the business scenario step;
collecting a second set of system readings after the execution of the business scenario step;
measuring the business scenario step performance using the first and the second set of system readings; and
displaying measurement results.

2. The method of claim 1, wherein identifying a business scenario step comprises acquiring a name of the business scenario step from a predefined list of business scenario steps.

3. The method of claim 1, wherein collecting the first set of system readings comprises:
receiving a first memory usage of the enterprise environment;
receiving a first set of elapsed CPU times of all processes involved in the enterprise environment;
acquiring a garbage collection log pointer to the end of garbage collection log files of the enterprise environment;
acquiring a back-end usage log pointer to the end of back-end usage log files of the enterprise environment; and
acquiring a HTTP session log pointer to the end of HTTP session log files of the enterprise environment.

4. The method of claim 3, wherein collecting the second set of system readings comprises:
receiving a second memory usage of the enterprise environment;
receiving a second set of elapsed CPU times of all processes involved in the enterprise environment;
collecting garbage collection logs from the garbage collection log pointer to the end of the garbage collection log files of the enterprise environment;
collecting back-end usage logs from the back-end usage log pointer to the end of the back-end usage log files of the enterprise environment; and
collecting HTTP session logs from the HTTP session log pointer to the end of the HTTP session log files of the enterprise environment.

5. The method of claim 1, wherein measuring the business scenario step performance comprises:
calculating an amount of memory used by the enterprise environment during the business scenario step execution;
calculating an amount of elapsed CPU times used by all processes involved in the enterprise environment during the business scenario step execution;
calculating a number and duration of all roundtrips between the enterprise environment and all back-ends involved in the business scenario step execution; and
calculating a number and duration of all roundtrips between an HTTP browser, used to trigger the business scenario step execution, and the enterprise environment.

6. A tool for performance measurement of a business scenario step in an enterprise environment, comprising:
a business scenario step reader to identify a business scenario step;
a data collector to collect a first set of system readings prior to the business scenario step execution and a second set of system readings after the business scenario step is executed;
a data analyzer to measure the business scenario step performance using the first and the second set of system readings; and
a report generator to generate user readable reports from the measurements performed by the data analyzer.

7. The tool of claim 6, wherein the business scenario step reader comprises an interface to acquire a name of the business scenario step from a predefined list of business scenario steps.

8. The tool of claim 6, wherein the first set of system readings comprises:
a first memory usage of the enterprise environment;
a first set of elapsed CPU times of all processes involved in the enterprise environment;
a garbage collection log pointer to the end of garbage collection log files of the enterprise environment;
a back-end usage log pointer to the end of back-end usage log files of the enterprise environment; and
a HTTP session log pointer to the end of HTTP session log files of the enterprise environment.

9. The tool of claim 8, wherein the second set of system readings comprises:
a second memory usage of the enterprise environment;
a second set of elapsed CPU times of all processes involved in the enterprise environment;
garbage collection logs from the garbage collection log pointer to the end of the garbage collection log files of the enterprise environment;
back-end usage logs from the back-end usage log pointer to the end of the back-end usage log files of the enterprise environment; and
HTTP session logs from the HTTP session log pointer to the end of the HTTP session log files of the enterprise environment.

10. The tool of claim 6, wherein the data analyzer measurements comprise:
a calculation of an amount of memory used by the enterprise environment during the business scenario step execution;
a calculation of an amount of elapsed CPU times used by all processes involved in the enterprise environment during the business scenario step execution;
a calculation of a number and duration of all roundtrips between the enterprise environment and all back-ends involved in the business scenario step execution; and
a calculation of a number and duration of all roundtrips between an HTTP browser, used to trigger the business scenario step execution, and the enterprise environment.

11. A machine readable medium having a set of instruction stored therein which when executed cause a machine to perform a set of operations measuring the performance of a business scenario step in an enterprise environment, comprising:
identifying a business scenario step;
collecting a first set of system readings prior to execution of the business scenario step;
collecting a second set of system readings after the execution of the business scenario step;
measuring the business scenario step performance using the first and the second set of system readings; and
displaying measurement results.

12. The machine readable medium of claim 11, having a set of instruction stored therein which when executed cause a machine to perform a set of operations, wherein identifying a business scenario step comprises acquiring a name of the business scenario step from a predefined list of business scenario steps.

13. The machine readable medium of claim 11, having a set of instruction stored therein which when executed cause a machine to perform a set of operations, wherein collecting the first set of system readings comprises:
receiving a first memory usage of the enterprise environment;
receiving a first set of elapsed CPU times of all processes involved in the enterprise environment;
acquiring a garbage collection log pointer to the end of garbage collection log files of the enterprise environment;
acquiring a back-end usage log pointer to the end of back-end usage log files of the enterprise environment; and
acquiring a HTTP session log pointer to the end of HTTP session log files of the enterprise environment.

14. The machine readable medium of claim 13, having a set of instruction stored therein which when executed cause a machine to perform a set of operations, wherein collecting the second set of system readings comprises:
receiving a second memory usage of the enterprise environment;
receiving a second set of elapsed CPU times of all processes involved in the enterprise environment;
collecting garbage collection logs from the garbage collection log pointer to the end of the garbage collection log files of the enterprise environment;
collecting back-end usage logs from the back-end usage log pointer to the end of the back-end usage log files of the enterprise environment; and
collecting HTTP session logs from the HTTP session log pointer to the end of the HTTP session log files of the enterprise environment.

15. The machine readable medium of claim 11, having a set of instruction stored therein which when executed cause a machine to perform a set of operations, wherein measuring the business scenario step performance comprises:
calculating an amount of memory used by the enterprise environment during the business scenario step execution;
calculating an amount of elapsed CPU times used by all processes involved in the enterprise environment during the business scenario step execution;
calculating a number and duration of all roundtrips between the enterprise environment and all back-ends involved in the business scenario step execution; and
calculating a number and duration of all roundtrips between an HTTP browser, used to trigger the business scenario step execution, and the enterprise environment.
